(19) United States
(12) Patent Application Publication
(10) Pub. No.: US 2012/0235094 A1
(43) Pub. Date: Sep. 20, 2012

(54) SILICA NANOFIBER/METAL OXIDE NANOCRYSTAL COMPOSITE AND METHOD FOR PRODUCING THE SAME

(75) Inventors: Pei-Xin Zhu, Chiba (JP); Ren-Hua Jin, Chiba (JP)

(73) Assignees: DIC Corporation, Tokyo (JP); Kawamura Institute of Chemical Research, Chiba (JP)

(21) Appl. No.: 13/512,854

(22) PCT Filed: Nov. 29, 2010
(86) PCT No.: PCT/JP2010/071217

§ 371 Date: May 30, 2012

(30) Foreign Application Priority Data
Nov. 30, 2009 (JP) 2009-271627

(51) Int. Cl. B05D 3/02; C09K 11/59

(52) U.S. Cl. 252/301.4 R; 427/226; 428/401

(57) ABSTRACT

A silica nanofiber/metal oxide nanocrystal composite is produced by a method including associating a polymer having a linear polyethyleneimine skeleton in a water-based medium in the presence of ice, adding alkoxysilane to the water-based medium obtained in the above step to form a composite nanofiber including the associate and silica that covers the associate, while the fiber spontaneously forms a disc-shaped network structure, a step of depositing a metal oxide on a surface of the fiber by mixing the disc-shaped structure obtained in the above step with a hydrolyzable metal compound, and a step of calcining the disc-shaped. structure obtained in the step above to form a silica nanofiber through removal of the polymer in the fiber, to convert the metal oxide into a nanocrystal, and to bond the nanocrystal to the fiber. When zinc oxide is used as the metal oxide, the composite functions as a luminous body.

### CROSS REFERENCE TO PRIOR APPLICATIONS

This application is a U.S. National Phase application under 35 U.S.C. 371 of International Application No. PCT/JP2010/071217, filed on Nov. 29, 2010 and claims benefit of priority to Japanese Patent Application No. 2009-271627, filed on Nov. 30, 2009. The International Application was published in Japanese on Jun. 3, 2011. as NO 2011/065521 A1 under PCT Article 21 (2). The contents of the applications are hereby incorporated by reference.

### TECHNICAL FIELD

The present invention relates to a disc-shaped silica nanofiber/metal oxide nanocrystal composite obtained by using, as a template, a disc-shaped micrometer-scale structure formed through intertwining of a silica nanofiber and by bonding one or more metal oxide nanocrystals to a surface layer of the silica nanofiber in the disc-shaped structure in a scattered manner. The present invention also relates to a method for producing the composite and a luminous body composed of the composite.

### BACKGROUND ART

Inorganic metal oxides formed in the order of nanometers often exhibit new properties and functions, which are not seen in metal oxide bulk materials. By using such inorganic metal oxides, novel material/product design can be achieved. In particular, metal oxides having semiconductivity have the potential in optical, optical communications, electric, and magnetic fields. Nanoparticles and ultra-thin films of such metal oxides have been rapidly developed.

However, it is difficult to produce a one-dimensional nanostructure composed of an inorganic metal oxide and to precisely control the size of the structure in the order of nanometers or micrometers. A machining process that has been conventionally used has limitation on nanomachining. An electrospinning method that has been often used to form a nanofiber structure in recent years has some problems in that the synthesis efficiency of a material is low and thus mass production is not easily achieved, and it is practically impossible to control a regular fine structure of a material when a multiphase oxide is synthesized.

It is no exaggeration to say that metal oxides are a gold mine of high-performance materials. For example, titanium oxide has been conventionally used as a white pigment. However, in recent years, titanium oxide has been widely used for cosmetics and interference pigments by utilizing a reflection/refraction phenomenon of light, which is based on a high refractive index of titanium oxide, and thus titanium oxide is highly expected as a material constituting photonic crystals. In addition, it is well known that titanium oxide is effectively used as a photocatalyst, and titanium oxide has been widely applied to solar cells, photolysis of substances, and sterilization, antimicrobial, and deodorization systems that use an oxidation reaction.

Various metal oxides such as iron oxide, zinc oxide, tungsten oxide, zirconia, cobalt oxide, manganese oxide, and alumina have excellent heat resistance, insulating property, electrical properties, semiconductivity, luminous property, magnetic properties, and catalytic property and thus have been widely put to practical use.

To further expand the applications of the metal oxides having such properties and produce better properties, a structure composed of a metal oxide needs to be formed in the order of nanometers and the size of a metal oxide crystallite in the structure needs to be controlled. Spherical nanoparticles of an oxide, layered nanofibers having a single-phase or multiphase oxide, and nanotubes are exemplified.

A composite including silica as a core and titanium oxide as a shell layer has been widely known as a nanostructure of titanium oxide. Furthermore, the development concerning a titanium oxide nanotube produced using powdery titanium oxide as a starting material has been widely known. However, a nanostructure of titanium oxide has many practical problems such as low mechanical strength, low heat stability, and working limit.

Since nanoparticles or nano-thin films of silica are relatively easily prepared, composite materials obtained by forming an immobilized layer of titanium oxide on the surfaces of the nanoparticles or nano-thin films have been widely investigated as nanostructures including silica and titanium oxide in a combined manner (e.g., refer to NPLs 1 and 2). To effectively produce various functions of titanium oxide, such as catalytic property, sterilization, antimicrobial property, and deodorization, a structure having a large contact area with a target substance, for example, a nonwoven structure or a sponge-like network structure is effectively used. However, since it is difficult to form a two-dimensional structure using the above-described particulate or thin film composite material, a structure having a large specific surface cannot be realized.

In recent years, a process for producing an oxide nanofiber by an electrospinning method has been actively developed (e.g., refer to PTL, 1). An electrospinning method is a method in which high voltage is applied to a polymer solution containing a raw material polymer such as an oxide precursor dissolved therein to fragment the polymer solution, and a nano fiber is collected on a grounded target as a solvent vaporizes. Therefore, it is difficult to produce a fiber having a diameter of 100 nm or less due to limitation of machine performance. Furthermore, in is fundamentally impossible to form a complicated fine structure (e.g., a multilayer structure of an oxide or formation of a composite with a nano-metal). An electrospinning method also requires a large specialized apparatus and thus the production efficiency of a fiber is low.

In view of the foregoing problems, the inventors of the present invention have already provided a method for forming a composite by using a silica/polyethyleneimine composite nanofiber as a base and depositing a titanium oxide layer thereon (e.g., refer to PTL 2). However, the size of a titanium oxide crystal could not be controlled by this method. The silica/polyethyleneimine composite nanofiber serving as a base had a large thickness of several tens nm or more, and the fiber became thicker due to titanium oxide that thickly covered the fiber. In addition, there is no mention about formation of a composite with metal oxides other than titanium oxide.

### CITATION LIST

### Patent Literature

PTL 1: Japanese Unexamined Patent Application Publication No. 2007-9398

PTL 2: Japanese Unexamined Patent Application Publication No. 2006-213888

### Non Patent Literature

NPL 1: Baskaran at al., J. Am. Ceram. Soc., 1998, vol. 81, p. 401

NPL 2: Jianxia Jiao et al., J. colloid & interface Sci., 2007, vol. 316, p. 596

### SUMMARY OF INVENTION

### Technical Problem

An object of the present invention is to provide a composite having a nano-interface (“nano to nano”) and formed by bonding one or more metal oxide nanocrystals to a structure composed of a silica nanofiber, and a simple method for producing the composite.

### Solution to Problem

As a result of eager study conducted to solve the problems above, the inventors of the present invention have found the following and have completed the present invention. That is, an associate serving as a template is formed by cleverly using a phenomenon in which a polymer having a linear polyethyleneimine skeleton grows into a nanofiber crystal under certain conditions. By causing a sol-gel reaction of alkoxysilane in the presence of the associate, a disc-shaped structure is formed, which is an aggregate of a silica/polyethyleneimine composite nanofiber having a thickness of 5 to 20 nm. An amine (ethyleneimine unit) that is present in the structure chemically functions, which allows a metal oxide to deposit on the structure. Subsequently, by calcining the structure, the metal oxide is formed into a nanocrystal while immobilized on the silica nanofiber.

The present invention provides a method for producing a silica nanofiber/metal oxide nanocrystal composite in which a metal oxide nanocrystal (A) is bonded to a silica nanofiber (B) constituting a disc-shaped network structure, the method including:

(I) a step of causing association of a polymer having a linear polyethyleneimine skeleton in a water-based medium in the presence of ice;

(II) a step of adding alkoxysilane to the water-based medium that contains an associate and is obtained in the step (I) to form a composite nanofiber including the associate as a core and silica that covers the associate, while the composite nanofiber spontaneously forms a disc-shaped network structure;

(III) a step of depositing a metal oxide (A′) on a. surface of the composite nanofiber constituting the disc-shaped structure obtained in the step (II) by mixing the disc-shaped structure with a hydrolyzable metal compound (C) in the water-based medium; and

(IV) a step of calcining, at 400 to 1250° C., the disc-shaped structure in which the metal oxide (A′) is deposited on the surface of the composite nanofiber and that is obtained in the step (III) to form a silica nanofiber (B) through removal of the polymer in the composite nanofiber, to convert the metal oxide (A′) into a metal oxide nanocrystal (A), and to bond the metal oxide nanocrystal (A) to the silica nanofiber (B).

The present invention also provides a silica nanofiber/metal oxide nanocrystal composite whose entire shape is a disc-like shape having a diameter of 5 to 20 μm and a thickness of 50 to 500 nm, wherein the composite has a basic structure in which a metal oxide nanocrystal (A) having a size of 2 to 10 nm is bonded to a surface of a silica nanofiber (B) having a thickness of 5 to 20 nm and is formed by intertwining the basic structure. The composite is also used as a luminous body.

### Advantageous Effects of Invention

In the method for producing a composite according to the present invention, a specialized apparatus or a large apparatus is not required, and a silica nanofiber/metal oxide nanocrystal composite is obtained from industrially easily available materials under relatively mild conditions. Therefore, the method can be widely used.

In the composite of the present invention, various metal oxides such as transition metal oxides, rare earth oxides, alumina, and magnesium oxide can be converted into a metal oxide nanocrystal bonded to a surface of a silica nanofiber. Since the composite is composed of an inorganic substance/metal oxide, the composite has high durability. Therefore, the silica nanofiber/metal oxide nanocrystal composite of the present invention can be expected to be used in various fields. For example, when titanium oxide is used as the metal oxide, the composite can be applied to photocatalysts, solar cells, sterilizing materials, antimicrobial materials, antiviral materials, water-purifying materials, and deodorizing materials. When zinc oxide is used as the metal oxide, the composite can be applied to luminous materials. When other oxides are used as the metal oxide, the composite can be applied to fluorescent materials, catalytic materials for organic chemical reactions, insulating materials, dielectric materials, magnetic materials, stimulus-responsive materials, and sensors.

### BRIEF DESCRIPTION OF DRAWINGS

FIG. 1 shows a measurement result or X-ray diffraction of a linear polyethyleneimine crystal in Synthetic Example.

FIG. 2 shows scanning electron micrographs of SNF@LPEI associates of composite nanofibers obtained in Synthetic Example.

FIG. 3 shows transmission electron micrographs of the SNF@LPEI associates of the composite nanofibers obtained in Synthetic Example.

FIG. 4 shows a micrograph of a scanning electron microscope of a composite 20-SNF@LPEI/5-TiO₂ obtained in Example 1.

FIG. 5 shows a micrograph of a transmission electron microscope of the composite 20-SNF@LPEI/5-TiO₂ obtained in Example 1.

FIG. 6 shows a measurement result of X-ray diffraction of a calcined composite 20-SNF/5-TiO₂ obtained in Example 1.

FIG. 7 shows a micrograph of a transmission electron microscope of the calcined composite 20-SNF/5-TiO₂ obtained in Example 1.

FIG. 8 shows measurement results of X-ray diffraction of calcined composites 20-SNF/WO₃ obtained in Example 2. In the drawing, 20-SNF/1-WO₃, 20-SNF/3-WO₂, 20-SNF/5-WO₃, and 20-SNF/6-WO₂ are shown from the bottom.

FIG. 9 shows a transmission electron micrograph of the calcined 20-SNF/3-WO₃ obtained in Example 2.

FIG. 10 shows a transmission electron. micrograph of a silica nanofiber/titanium oxide tungsten oxide nanocrystal composite obtained in Example 3.

FIG. 11 shows a scanning electron micrograph (top) and a transmission electron micrograph (bottom) of a silica nanofiber/zinc oxide nanocrystal composite obtained in Example 4.

FIG. 12 shows an image of luminescence (a) and a fluorescence excitation spectrum (b) of a silica nanofiber/zinc oxide nanocrystal composite powder in Example 5 under irradiation with black light.

FIG. 13 shows luminous properties exhibited by using a processed film made of a silica nanofiber/zinc oxide nanocrystal and polyethylene, the film being prepared in Example 6. FIG. 13 a) shows a commercially available ultraviolet chip. FIG. 13 b) shows an image of the commercially available ultraviolet chip in a lighted state. FIG. 13 c) shows an image in a lighted state, the image being obtained when the commercially available ultraviolet chip is capped with a processed film made of a silica nanofiber/zinc oxide nanocrystal and polyethylene. FIG. 13 d) shows a diffuse reflectance spectrum of light emitted from the chip capped with a processed film. FIG. 13 e) shows a diffuse reflectance spectrum of light emitted from an uncapped commercially available chip.

### DESCRIPTION OF EMBODIMENTS

Formation of a metal oxide nanocrystal normally requires a support. In particular, to control the size of a metal oxide nanocrystal to be 10 nm or less or a size of quantum dots, a support itself desirably has a one-dimensionally stretched nanofiber structure. In the case where the nanofiber component is silica, there are an infinite number of silanols on the surface of the nanofiber component. Such a silanol is a bonding site that is suitably bonded to a metal oxide nanocrystal. In other words, a composite having a nano-interface (“nano to nano”) between nanofiber silica and a nanocrystalline metal oxide in a latent manner can be obtained.

In the present invention, a process that has been developed by the inventors of the present invention is used as a method for forming a silica nanofiber that constitutes a support. That is, a phenomenon in which a polymer having a linear polyethyleneimine skeleton grows into a nanofiber crystal in water is used. By depositing silica on the nanofiber crystal of the polymer, a nanofiber including the silica and polymer in a composite manner and having a thickness of about 20 nm is formed as a primary structure. The nanofiber is two-dimensionally intertwined to prepare a disc-shaped structure.

Furthermore, by mixing the disc-shaped structure above with a metal compound serving as a metal oxide source in a water-based medium, the metal compound is caused to hydrolyze selectively on the surface of the nanofiber in the disc-shaped structure. Thus, a metal oxide is deposited. Subsequently, the structure is calcined to remove an organic component and to strengthen the bond between a metal oxide nanocrystal and a silica nanofiber.

### [Polymer Having Linear Polyethyleneimine Skeleton]

The linear polyethyleneimine skeleton in the present invention is a linear polymer skeleton having an ethyleneimine unit, which is a secondary amine, as a main structural unit. In the skeleton, there may be a structural unit other than the ethyleneimine unit. However, the polymer chain is preferably composed of a certain number of continuous ethyleneimine units to form a crystalline polymer nanofiber. The length of the linear polyethyleneimine skeleton is not particularly limited as long as the polymer having a linear polyethyleneimine skeleton can grow into a crystalline polymer nanofiber. To suitably form a crystalline polymer nanofiber, the number of repeating ethyleneimine units in the skeleton is preferably 10 or more and more preferably 20 to 10,000.

Any polymer may be used in the present invention as long as the polymer has the above-described linear polyethyleneimine skeleton in its structure. Even if the entire shape is a linear shape, a star-like shape, or a comb-like shape, any polymer that can provide a crystalline polymer nanofiber in a water-based medium may be used.

The polymer having a linear shape, a star-like shape, or a comb-like shape may be composed of a linear polyethyleneimine skeleton alone or may be a block copolymer including a block of a linear polyethyleneimine skeleton and blocks of other polymers. Examples of the other polymers include water-soluble polymers, e.g., polyethylene glycol, polypropionylethyleneimine, and polyacrylamide; and hydrophobic polymers, e.g., polystyrene, polyoxazolines such as polyphenyloxazoline, polyoctyloxazoline, and polydodecyloxazoline, and polyacrylates such as polymethyl methacrylate and polybutyl methacrylate. By forming a block copolymer using the other polymers, the shape of the crystalline polymer nanofiber can be adjusted.

In the case where the polymer having a linear polyethyleneimine skeleton has blocks of other polymers, the ratio of the linear polyethyleneimine skeleton in the polymer is not particularly limited as long as a crystalline polymer nanofiber can be formed. The ratio of the linear polyethyleneimine skeleton in the polymer is preferably 25 mol % or more, more preferably 40 mol % or more, and further preferably 50 mol % or more.

The polymer having a linear polyethyleneimine skeleton can be easily obtained by hydrolyzing a polymer (hereinafter abbreviated as “precursor polymer”) having a linear skeleton composed of a polyoxazoline serving as a precursor under an acidic or alkaline condition. Therefore, the entire shape such as a linear shape, a star-like shape, or a comb-like shape of the polymer having a linear polyethyleneimine skeleton can be easily designed by controlling the shape of the precursor polymer. The degree of polymerization and the terminal structure of the polymer can also be easily adjusted by controlling the degree of polymerization and terminal groups of the precursor polymer. Furthermore, in the case where a block copolymer having a linear polyethyleneimine skeleton is formed, a precursor polymer which is a block copolymer is employed and a linear skeleton composed of a polyoxazoline in the precursor polymer can be selectively hydrolyzed.

The polymer used in the present invention has crystallinity. That is, when the polymer is dissolved in hot water having a temperature of 80° C. or higher and then cooled, the polymer is spontaneously crystallized and an associate is formed. In the present invention, as described below, crystallization is performed in a water-based medium in the presence of ice. In this method, the growth of a crystalline polymer nanofiber is favorably suppressed. Compared with a nanofiber obtained by a conventional room temperature cooling method, the diameter of the crystalline polymer nanofiber is significantly small and can be controlled to be about 10 nm.

### [Disc-Shaped Structure Composed of Nanofiber Including Silica and Polymer in Composite Manner]

The composite of the present invention basically has a disc-shaped network structure, which is formed by the method below. An associate of a crystalline nanofiber that has a small diameter and into which the polymer having a linear polyethyleneimine skeleton grows in the presence of ice is used as a template. By causing a sol-gel reaction of alkoxysilane in a water-based medium, a composite nanofiber including the associate as a core and silica that covers the associate (hereinafter abbreviated as “composite nanofiber”) is formed. Such a composite nanofiber is intertwined and thus the disc-shaped network structure is spontaneously formed.

The composite nanofiber is a fibrous material, and has a thickness of 5 to 20 nm and an aspect ratio of 10 or more. The aspect ratio is preferably 100 or more. The composite nanofiber is two-dimensionally expanded in an intertwined state and is present in the form of a disc-shaped network structure like “instant noodle”.

The diameter of the disc-shaped structure is controlled in a range of 5 to 20 μm and preferably in a range of 5 to 10 μm. In the present invention, the disc shape does not necessarily mean a perfect circle and means a two-dimensionally expanded shape. Therefore, the diameter used herein is a length of the widest portion in a two-dimensionally expanded sheet-like structure, the length. being determined from a micrograph. The length of the two-dimensionally expanded sheet-like structure in a vertical direction is defined as a thickness of the disc-shaped structure. In the present invention, the thickness is controlled in a range of 50 to 500 nm.

### [Metal Oxide]

A metal oxide in the composite of the present invention. is preferably an oxide having semiconductivity. Examples of the metal oxide include titanium oxide, zinc oxide, tungsten oxide, barium oxide, iron oxide, zirconia, manganese oxide, cobalt oxide, germanium oxide, yttrium oxide, niobium oxide, cadmium oxide, tantalum oxide, and alumina. In particular, a composite containing zinc oxide has strong luminosity, and thus zinc oxide is preferably used when a luminous body is produced.

The metal oxide is a nanocrystal having a size of 2 to 10 nm and, in particular, having a size of quantum dots.

The metal oxide nanocrystal in the present invention is immobilized on the silica nanofiber constituting the disc-shaped structure. This immobilization is achieved by a Si—O-M (M: metal ion) bond between heterogeneous phases, that is, between a silica phase and a metal oxide phase.

### [Method for Producing Silica Nanofiber/Metal Oxide Nanocrystal Composite]

The inventors of the present invention have already provided a technology of forming a silica-containing nanostructure having a complicated shape. The silica-containing nanostructure is formed by using, as a reaction field, a crystalline associate into which a polymer having a linear polyethyleneimine skeleton grows in a self-organizing manner in a water-based medium and by condensing alkoxysilane on the surface of the associate in a solution through hydrolysis to deposit silica (refer to Japanese Unexamined Patent Application Publication Nos. 2005-264421, 2005-336440, 2006-063097, and 2007-051056).

The basic principle of this technology is that a crystalline associate of a polymer having a polyethyleneimine skeleton is caused to spontaneously grow in an aqueous solution. Once the crystalline associate is formed, a silica source is simply mixed in a dispersion liquid of the crystalline associate to cause spontaneous deposition of silica on the surface of the crystalline associate (so-called “sol-gel reaction”). The silica-containing structure obtained by this method is basically constituted by a nanofiber as a unit for forming the structure. However, when the crystal growth of the polymer is left without control, aggregation randomly occurs on the crystalline associate, which causes the structural irregularity of silica deposited on the crystalline associate. In particular, to further decrease the thickness of the nanofiber and control the thickness more efficiently, a time limit needs to be imposed in the growth process of the crystalline associate of the polymer having a polyethyleneimine skeleton.

The present invention provides a method for producing a silica nanofiber/metal oxide nanocrystal composite, the method including:

(I) a step of causing association of a polymer having a linear polyethyleneimine skeleton in a water-based medium in the presence of ice;

(II) a step of adding alkoxysilane to the water-based medium that contains an associate and is obtained in the step (I) to form a composite nanofiber including the associate as a core and silica that covers the associate, while the composite nanofiber spontaneously forms a disc-shaped network structure;

(III) a step of depositing a metal oxide (A′) on a surface of the composite nanofiber constituting the disc-shaped structure obtained in the step (II) by mixing the disc-shaped structure with a hydrolyzable metal compound (C) in the water-based medium; and

(IV) a step of calcining, at 400 to 1250° C., the disc-shaped structure in which the metal oxide (A′) is deposited on the surface of the composite nanofiber and that is obtained in the step (III) to form a silica nanofiber (B) through removal, of the polymer in the composite nanofiber, to convert the metal oxide (A′) into a metal oxide nanocrystal (A), and to bond the metal oxide nanocrystal (A) to the silica nanofiber (B). In the entire production process, it is particularly important to efficiently control the crystal growth of the polymer having a polyethyleneimine skeleton in the step (1).

### [Step of Preparing Polymer Crystal Dispersion Liquid]

In the production method of the present invention, a polymer having a linear polyethyleneimine skeleton dissolved in hot water is quickly mixed with a water-based medium in the presence of ice to instantly grow a polymer crystal, without employing a conventional method in which a polymer having a linear polyethyleneimine skeleton is dissolved in hot water and the solution is naturally cooled to room temperature to grow a polymer crystal. The polymer crystal obtained herein exhibits fluidity in a liquid. That is, a dispersion liquid of the polymer crystal is obtained.

In the step of obtaining the polymer crystal, the concentration of the polymer in hot water is preferably 0.5 to 10 wt % and more preferably 1 to 5 wt %. The temperature of the hot water solution of the polymer is set to be 70 to 100° C. and preferably 75 to 85° C.

When the hot water solution of the polymer is mixed with the water-based medium in the presence of ice, the mass ratio of the hot water solution of the polymer to ice may be in a range of 10/90 to 90/10. In the mixing, the stirring efficiency is preferably as high as possible. The term “water-based medium” collectively means water alone and a mixed solvent of water and a hydrophilic organic solvent that can be mixed with water in any ratio, such as methanol or ethanol. Herein, to efficiently obtain a polymer crystal, the ratio of the organic solvent used together with water is preferably 30% or less by mass. More preferably, water alone is used as the water-based medium. Examples of a method for mixing the hot water solution with the water-based medium include a method in which only ice is directly added to the hot water solution of the polymer, a method in which the hot water solution of the polymer is added to a container into which ice and the water-based medium have been inserted in advance, and a method in which ice and the water-based medium are added to the hot water solution of the polymer.

The temperature of the mixed solution after the hot water solution of the polymer and ice are mixed with each other is preferably 3 to 15° C. and more preferably 10° C. or lower.

When the mixed solution obtained by mixing ice is naturally cooled to room temperature, the mixed solution is brought into a milky state. In this state, the associate of the polymer crystal is stably dispersed in water.

### [Step of Forming Composite Nanofiber of Polymer and Silica]

By adding alkoxysilane serving as a silica source to the dispersion liquid of the polymer crystal in the milky state above and stirring the mixture at room temperature (20 to 25° C.), an aggregate (disc-shaped structure) of a composite nanofiber including polymer and silica in a composite manner can be formed. The stirring time is set to be 10 to 60 minutes. Normally, the stirring is completed within a range of 20 to 40 minutes.

The alkoxysilane used herein is suitably an alkoxysilane used in a sol-gel reaction.

Examples of the alkoxysilane include tetramethoxysilane, an oligomer of a methoxysilane condensate, tetraethoxysilane, and an oligomer of an ethoxysilane condensate; alkyl-substituted alkoxysilanes such as methyltrimethoxysilane, methyltriethoxysilane, ethyltrimethoxysilane, ethyltriethoxysilane, n-propyltrimethoxysilane, n-propyltriethoxysilane, iso-propyltrimethoxysilane, and iso-propyltriethoxysilane; and 3-chloropropyltrimethoxysilane, 3-chloropropyltriethoxysilane, vinyltrimethoxysilane, vinyltriethoxysilane, 3-glycidoxypropyltrimethoxysilane, 3-glycidoxypropyltriethoysilane, -aminopropyltrimethoxysilane, 3-aminopropyltriethoxysilane, 3-mercaptopropyltrimethoxysilane, 3-mercaptotriethoxysilane, 3,3,3-trfluoropropyltrimethoxysilane, 3,3,3-trifluoropropyltriethoxysilane, 3-methacryloxypropyltrimethoxysilane, 3-methacryloxypropyltriethoxysilane, phenyltrimethoxysilane, phenyltriethoxysilane, p-chloromethylphenyltrimethoxysilane, p-chloromethylphenylmethoxysilane, dimethyldimethoxysilane, dimethyldiethoxysilane, diethyldimethoxysilane, and diethyldiethoxysilane. These alkoxysilanes can be used alone or in combination.

The thickness of the composite nanofiber obtained above is also dependent on the concentration of the alkoxysilane added. To obtain a relatively thin composite nanofiber, the concentration of the alkoxysilane is preferably decreased. To obtain a thick composite nanofiber, the concentration of the alkoxysilane is preferably increased.

That is, to adjust the thickness of the composite nanofiber to 10 nm or less, the amount of silicon in the alkoxysilane is desirably 1 to 1.5 times the amount of the polymer (on a mass basis). If the amount of silicon in the alkoxysilane is 2 or more times the amount of the polymer, the thickness of the composite nanofiber can be increased to 15 nm or more.

The sol-gel reaction that produces the composite nanofiber does not occur in a water-based liquid phase in water or the water-based medium containing a hydrophilic organic solvent, but proceeds on the surface of the polymer crystal. Therefore, the reaction conditions for forming a composite nanofiber can be freely selected as long as the polymer crystal is not dissolved.

In the process of the sol-gel reaction, the water-based medium is most preferably water alone to stabilize the polymer crystal, but a hydrophilic organic solvent, that can be mixed with water in any ratio may be contained. In this case, the ratio of water in the medium is preferably 20% or more by mass and more preferably 40% or more by mass.

In the sol-gel reaction, by excessively increasing the amount of alkoxysilane serving as a silica source compared with the amount of ethyleneimine, which is a monomer unit of polyethyleneimine, the composite nanofiber can be suitably obtained. Regarding the degree of the excessive increase, the amount of alkoxysilane is preferably 1 to 20 times the equivalent amount of ethyleneimine. To control the thickness of the composite nanofiber to about 10 nm, the amount of alkoxysilane is more preferably 1 to 10 times the equivalent amount of ethyleneimine.

The concentration of the polymer crystal (associate) in the sol-gel reaction liquid is preferably 0.1 to 5 wt % relative to the amount of the polyethyleneimine skeleton contained in the polymer.

### [Step of Forming Polymer/Silica Nanofiber/Metal Oxide Composite]

A solution of a hydrolyzable metal compound (C) is mixed with or brought into contact with the aggregate (disc-shaped structure) of the composite nanofiber that includes polymer and silica in a composite manner and is obtained in the step above. Thus, a metal oxide can be deposited in a surface portion of the silica through a catalytic effect of an ethyleneimine unit in the composite nanofiber.

The metal compound (C) can be used in the form of an aqueous solution or a water-based solution containing an alcohol. The concentration of the solution is not particularly limited, but may be 0.1 to 80 wt % and is preferably 1 to 40 wt %.

The amount of the metal compound (C) used (by mass) may be equal to or more than the amount of the composite nanofiber including polymer and silica.

The reaction time for the deposition of the metal oxide (A′) through hydrolysis is dependent on the type and concentration of the metal compound (C) used as a raw material, but is generally 10 minutes to 5 hours.

In addition to a batch method, the metal compound (C) can be brought into contact with the aggregate of the composite nanofiber including polymer and silica by a continuous flow method. That is, a column is filled with the aggregate of the composite nanofiber in a dry or wet process and then a solution of the metal compound (C) is caused to flow in the column. Preferably, a column is filled with the composite nanofiber dispersed in water or an organic solvent, and a solution of the metal compound (C) in a volume about 10 times larger than the total volume of the composite nanofiber is caused to pass through the column in a circulating manner. The number of circulations is normally 3 to 10 and may be 10 or more.

Examples of the metal compound (C) include metal alkoxides, metal acetates, metal nitrates, and metal chlorides. The metal compound (C) is hydrolyzed into a metal oxide (A′).

Examples of the metal compound (C) include alkoxides of metals such as titanium, vanadium, manganese, iron, cobalt, zinc, germanium, yttrium, zirconium, niobium, cadmium, tantalum, and aluminum. The type of alkoxide is not particularly limited, and may be, for example, methoxide, ethoxide, propoxide, isopropoxide, or butoxide. Furthermore, the type of alkoxide may be an alkoxide derivative obtained by substituting part of an alkoxy group with β-diketone, β-ketoester, alkanolamine, or alkylalkanolamine. These metal alkoxides may be used alone or in combination.

In addition, an acetate of a metal such as titanium, vanadium, manganese, iron, cobalt, zinc, germanium, yttrium, zirconium, niobium, cadmium, tantalum, or aluminum can be suitably used.

Moreover, a nitrate or chloride of a metal such as titanium, vanadium, manganese, iron, cobalt, zinc, germanium, yttrium, zirconium, niobium, cadmium, tantalum, or aluminum may be used.

After the solution of the metal compound (C) is circulated, a hydrophilic organic solvent such as methanol, ethanol, or acetone is preferably caused to flow in the column to wash the aggregate (disc-shaped structure) of the composite nanofiber.

When the solution of the metal compound (C.) is mixed with or brought into contact with the aggregate, a solution containing a plurality of metal compounds (C) can be used. Alternatively, solutions containing different metal compounds (C) can be sequentially mixed with or brought into contact with the aggregate.

### [Step of Producing Silica Nanofiber/Metal Oxide Nanocrystal Composite]

By calcining the structure in which the metal oxide is deposited on the surface of the aggregate of the composite nanofiber obtained above, a silica nanofiber/metal oxide nanocrystal composite, which is a target product of the present invention, can be produced.

The calcination temperature is set to be 400° C. or higher and preferably 1250° C. or lower. The calcination temperature is more preferably set to be 450 to 900° C. because a polymer component in the composite nanofiber can be efficiently removed. Through this calcination process, the crystallization of a metal oxide proceeds, and thus a nanocrystal grows and a Si—O-M bond is formed. in the interface between silica and the metal oxide.

The calcination is preferably performed in an air atmosphere or an oxygen atmosphere to increase the efficiencies of removal of the polymer and crystal growth. The calcination time is dependent on the calcination temperature, but is about 1 to 5 hours.

The calcination conditions such as a temperature-increasing rate and a holding time at a constant temperature can be set using a temperature program.

After or when an amine compound is adsorbed to the silica nanofiber/metal oxide nanocrystal composite produced through the calcination, the same metal compound as that used in the step above or a different metal compound (C) is further brought into contact with the composite. Consequently, the metal compound can be further grown using, as a nucleus, the metal oxide nanocrystal that has been formed or a different metal oxide can be formed in a composite manner. Subsequently, through the same calcination step as above, the adsorbed amine compound can be removed and the newly-deposited metal oxide can be converted into a nanocrystal. As a result, the content of the metal oxide nanocrystal in the composite can be effectively increased.

The amine compound that can be used herein is not particularly limited as long as the amine compound can hydrolyze the metal compound (C). The amine compound is preferably a linear or branched polyamine such as polyalkyleneimine, polyarylamide, or polyvinylamine or a low-molecular-weight amine such as ethylenediamine, diaminoethylamine, or aminoethanol in terms of ease of adsorption to a silica nanofiber and further facilitation of the hydrolysis reaction. The adsorption method of the amine compound to the silica nanofiber is also not particularly limited. For example, the adsorption can be achieved by immersing the silica nanofiber in a water-based medium solution containing 1 to 20% by mass of amine compound and then performing stirring at room temperature to 100° C. or lower for 30 minutes to 1 day. This adsorption step and the contact of the metal compound (C) may be performed at the same time. Alternatively, after the adsorption step, the contact of the metal compound (C) may be performed. The contact of the metal compound (C) and the subsequent calcination step are performed as described above.

### [Luminous Body Composed of Silica Nanofiber/Zinc Oxide Nanocrystal Composite]

A solid powder of the silica nanofiber/zinc oxide nanocrystal composite produced by the above-described method has a structure in which zinc oxide nanoparticles having a size of quantum dots are baked on the surface of the silica nanofiber and a nano-interface is formed between heterogeneous phases, that is, between a silica phase and a zinc oxide phase. Therefore, when zinc oxide is photoexcited (irradiated with ultraviolet rays), the conversion of the excitation energy into a non-radiative transition state is suppressed. Consequently, the excitation energy can be efficiently released as light energy. In other words, the luminous quantum yield is higher than that of typical zinc oxide nanoparticles. Accordingly, a function as a luminous body is improved.

In the silica nanofiber/zinc oxide nanocrystal composite of the present invention, even if the content of zinc oxide is about 10% by mass, the luminescence intensity of the zinc oxide is higher than that of pure zinc oxide. This composite can be dispersed in, for example, transparent plastic or glass and molded. When the plate-shaped, sheet-shaped, or film-shaped structure that has been molded is irradiated with ultraviolet rays, visible light is emitted from the structure. Thus, it can be confirmed that the structure has a function as a luminous body.

### EXAMPLES

The present invention will now be more specifically described based on Examples and Reference Examples, but is not limited thereto. Herein, “%” means “% by mass” unless otherwise specified.

### [Analysis by X-Ray Diffraction Method]

A sample that had been isolated and dried was placed on a holder for test samples, and set in a wide angle X-ray diffractometer “Rint-Ultma” manufactured by Rigaku Corporation. The measurement was performed using a Cu/Kα ray, at 40 kV/30 mA, at a scanning speed of 1.0°/min, and in a scanning range of 10 to 70°.

### [Differential Scanning Calorimetry]

A sample that had been isolated and dried was weighed using a measurement patch, and set in a differential scanning calorimeter (TG-TDA6300) manufactured by SII Nanotechnology Inc. The measurement was performed at a temperature-increasing rate of 10° C./min in a temperature range of 20 to 800° C.

[Analysis of Shape with Scanning Electron Microscope]

A sample that had been isolated and dried was placed on a glass slide, and observed with a surface observation device VE-7800 manufactured by KEYENCE CORPORATION.

[Analysis of Fine Structure with Transmission Electron Microscope]

A sample dispersed in ethanol was placed on a sample supporting film, and observed with a transmission electron microscope (JEM-2000FS) manufactured by JEOL Ltd.

### Synthetic Example

### [Synthesis of Composite Nanofiber (SNF@LPEI) of Silica and Linear Polyethyleneimine and Associate of Composite Nanofiber]

### <Synthesis of Linear Polyethyleneimine (LPEI)>

Thirty grams of commercially available polyethyloxazoline (average molecular weight: 50,000, average degree of polymerization: about 500, manufactured by Sigma-Aldrich Co. LLC.) was dissolved in 150 mL of 5 M aqueous hydrochloric acid solution. The solution was heated. to 90° C. with an oil, bath and stirred at that temperature for 10 hours. Subsequently, 500 mL of acetone was added to the reaction solution to completely precipitate the polymer. The precipitate was filtered and washed with methanol three times to obtain white powder of polyethyleneimine. As a result of an identification of the powder with ¹H-NMR (deuterium oxide), it was confirmed that peaks an 1.2 ppm (6H-) and 2.3 ppm (CH₂) derived from an ethyl group on a side chain of polyethyloxazoline were completely eliminated. This means that polyethyloxazoline was completely hydrolyzed into polyethyleneimine.

The powder was dissolved in 50 mL of distilled water, and 500 mL of 15% ammonia water was added dropwise to the solution under stirring. After the mixed solution was left to stand for one night, a precipitated polymer associate powder was filtered and washed with cold water three times. The washed crystal powder was dried in a desiccator at room temperature to obtain a linear polyethyleneimine (LPEI) powder. The yield was 22 g (containing water of crystallization). When polyoxazoline is hydrolyzed into polyethyleneimine, only the side chain reacts and the main chain does riot change. Therefore, the degree of polymerization of LPEI is about 500, which is the same as the degree of polymerization before hydrolysis.

### [Preparation of Composite Nanofiber and Associate]

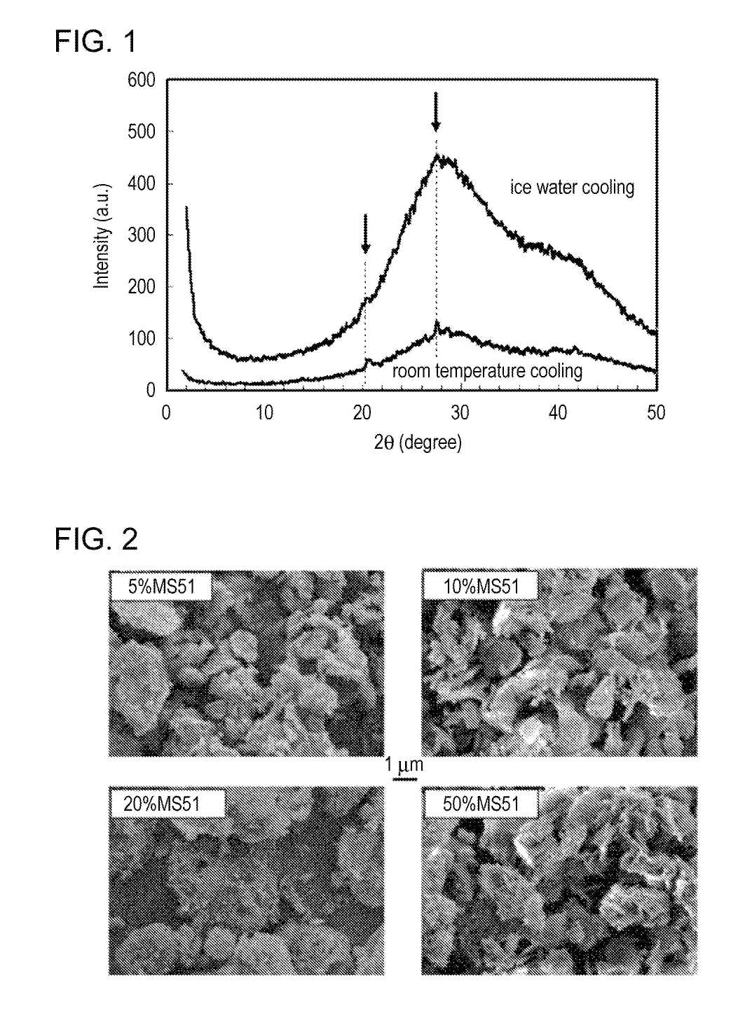

Ten grams of the LPEI powder obtained above was weighed and dispersed in 500 g of distilled water to prepare an LPEI dispersion liquid. The dispersion liquid was heated to 90° C. with an oil bath to obtain a completely transparent aqueous solution having a concentration of 2%. To the hot aqueous solution, 500 g of small pieces of ice were quickly added under vigorous stirring. Herein, the temperature of the water medium was 4° C. Consequently, the transparent LPEI aqueous solution instantly became cloudy and changed into an opaque milky colloidal solution (in fact, the concentration of LPEI decreased to 1%). As a result of the measurement by X-ray diffraction (FIG. 1), an associate in the colloidal solution obtained by the ice water cooling exhibited the crystallinity of LPEI. However, the diffraction peak was weaker than that of a crystal obtained by typical room temperature cooling, and thus it was confirmed that the crystal size was decreased.

Ten milliliters of ethanol solution containing 5%, 10%, 20%, or 50% by volume of a tetramethoxysilane partial condensate [“Methyl Silicate 51” manufactured by COLCOAT CO., LTD. (hereinafter referred to as “MS51”)] was added to 20 mL of the colloidal solution of the LPEI associate obtained. above. The mixed solution was lightly stirred for one minute, left to stand for 60 minutes, and washed with an excessive amount of ethanol three times using a centrifuge. The solid was collected and dried at room temperature to obtain an associate of a composite nanofiber including the LPEI as a core and silica that covered the LPEI. The associates made from 5%, 10%, 20%, and 50% by volume of tetramethoxysilane partial condensates are respectively referred to as 5-SNF@LPEI, 10-SNF@LPEI, 20-SNF@LPEI, and 50-SNF@LPEI. Table 1 shows the compositions and physical properties.

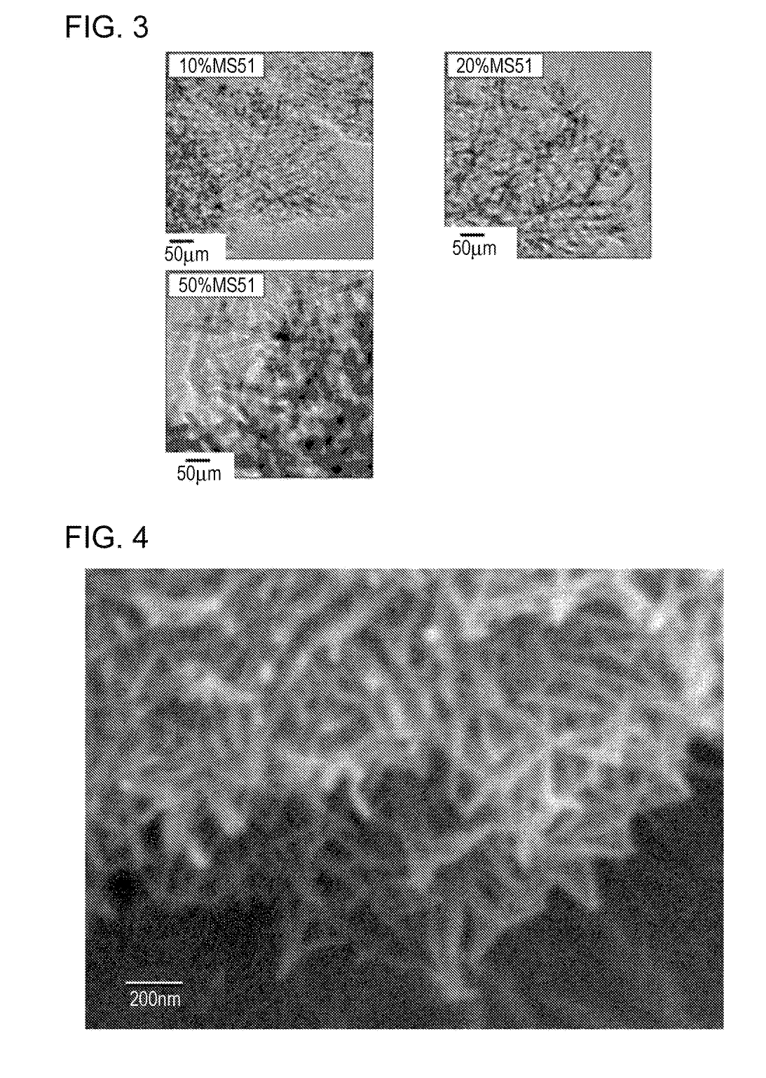

As a result of the observation of each of the associates of the composite nanofibers obtained above with a scanning electron microscope (FIG. 2), it was confirmed that the associate was a disc-shaped network structure like “instant noodle” that was formed through association of many nanofibers. As a result of the observation with a transmission electron microscope (FIG. 3), it was confirmed that, when the disc-shaped structure was formed under the condition that the concentration of MS-51 was high, the thickness of the composite nanofiber constituting the disc-shaped structure was increased. Table 1 shows an average diameter of the composite nanofiber obtained under each of the conditions. Furthermore, ²⁹Si-NMR measurement suggested that the molar ratio (Q4/Q3) of Q4 [Si (OSi)₄] to Q3 [HO—Si(OSi)₃] in a Si bonding state in the composite nanofiber obtained under each of the conditions was decreased as the concentration of a silica source increased. That is, the degree of condensation of silica combined with LPEI increased as the concentration of a silica source decreased. As a result of thermal analysis, it was found that the content (weight loss) of the polymer in the composite nanofiber increased as the concentration of a silica source decreased (Table 1).

TABLE 1
Composite nanofiber

| | Name of composite | | | |
|---|---|---|---|---|
| | 5-SNF | 10-SNF | 20-SNF | 50-SNF |
| | @LPEI | @LPEI | @LPEI | @LPEI |
| LPEI associate liquid (ml) | 20 | 20 | 20 | 20 |
| MS51 ethanol solution (vol %) | 5 | 10 | 20 | 50 |
| LPEI content (wt %) | 27.3 | 24.4 | 21.7 | 17.8 |
| Q4/Q3 | 1.65 | 1.51 | 1.23 | 0.88 |
| Diameter of fiber (nm) | 8 | 10 | 15 | 20 |
| Weight loss (%) | 26.8 | 24.4 | 21.7 | 17.8 |

### Example 1

One gram of each of the powders of four associates such as 5-SNF@LPEI, 10-SNF(3LPEI, 20-SNF@LPEI, and 50-SNF@LPEI obtained above was added to 100 ml of an aqueous solution containing 5 vol % TC310 (water-soluble titanium lactate manufactured by Matsumoto Chemical Industry Co., Ltd.). The mixed solution was lightly stirred and then left to stand at room temperature (20 to 25° C.) for two hours. The mixed solution was then subjected to centrifugation, washed with distilled water, and dried at room temperature for one night to obtain a white powder. The powder obtained using 20-SNF@LPEI was observed with a scanning electron microscope, and it was confirmed that an aggregate of the composite nanofiber was formed and titanium oxide was formed on the surface of the aggregate in a composite manner (FIG. 4). As a result of fluorescence X-ray analysis, it was suggested that, as the content of LPEI in the composite nanofiber (SNF@LPEI) used increased, titanium oxide was more easily deposited and the amount of deposition tended to increase (Table 2).

TABLE 2
Composite of composite nanofiber and titanium oxide

| | Name of composite | | | |
|---|---|---|---|---|
| | 5-SNF | 10-SNF | 20-SNF | 50-SNF |
| | @LPEI/ | @LPEI/ | @LPEI/ | @LPEI/ |
| | 5-TiO₂ | 5-TiO₂ | 5-TiO₂ | 5-TiO₂ |
| SNF@LPEI raw material | 5-SNF | 10-SNF | 20-SNF | 50-SNF |
| | @LPEI | @LPEI | @LPEI | @LPEI |
| Source of titanium oxide | 5 | 5 | 5 | 5 |
| (vol %) | | | | |
| Amount of deposition of | 61 | 57 | 15 | 5 |
| titanium oxide (%) | | | | |

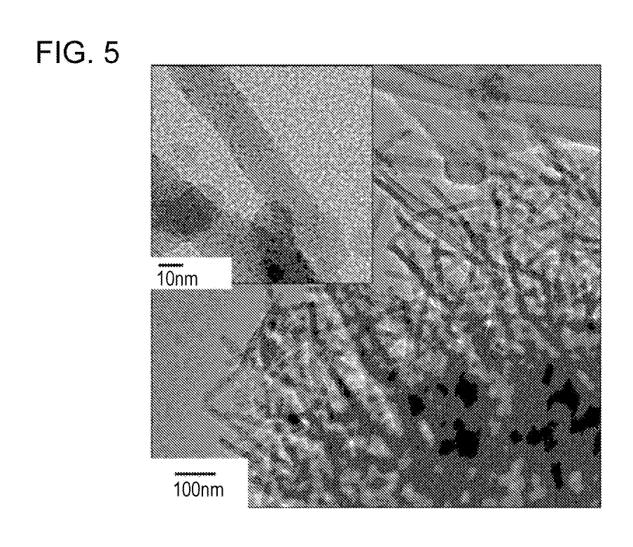

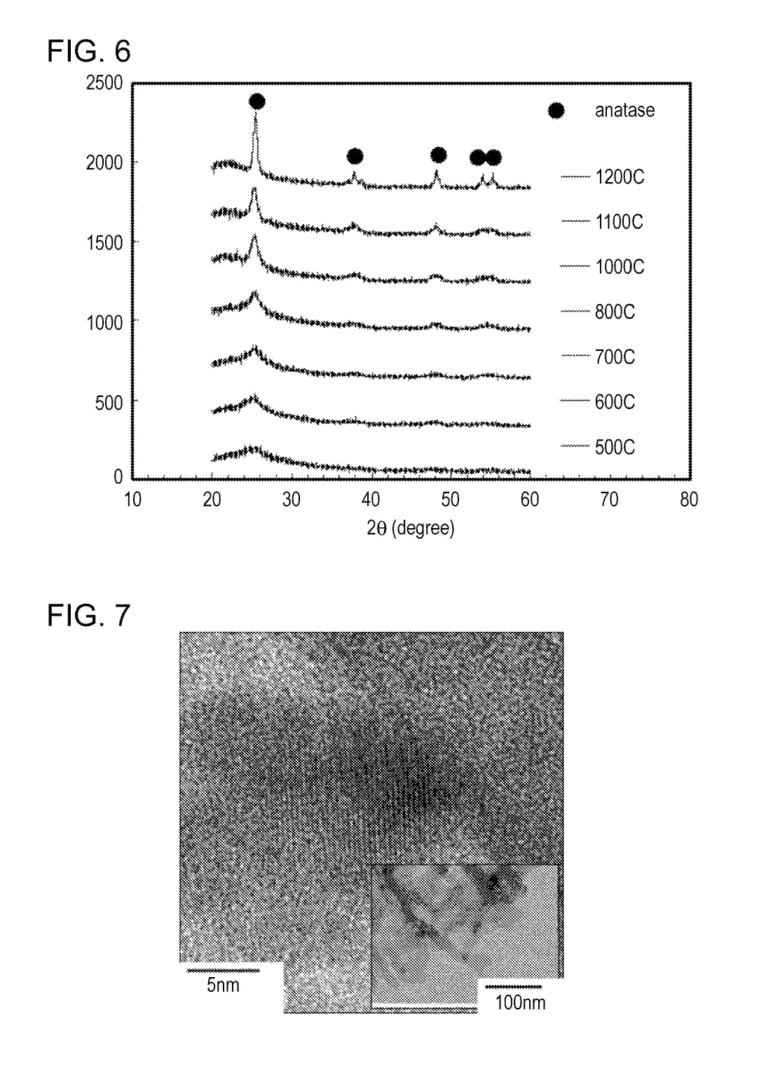

Extremely small black spots were observed on the 20-SNF@LPEI composite nanofiber with a transmission electron microscope (FIG. 5). This sample was calcined at a temperature of up to 1200° C. in the air, but the crystal structure of titanium oxide was an anatase crystal structure and did not change into a rutile crystal structure, though the crystallite size of titanium oxide slightly increased (FIG. 6). Through the transmission electron microscopy of the sample 20-SNF/TiO₂ in which LPEI was completely removed by performing calcination at a high temperature of 1200° C. for one hour, a domain indicating crystal stripes of titanium oxide was observed (FIG. 7). From this observation, the size of the crystal stripes was estimated to be 10 nm or less. The powders of 5-SNF@LPEI, 10-SNF@LPEI, and 50-SNF@LPEI of the composite nanofibers were also calcined at 1200° C., and the results were the same as above.

### Example 2

### <Silica Nanofiber/Tungsten Oxide Nanocrystal Composite>

The powder of 20-SNF@LPEI associate of the composite nanofiber obtained in Synthetic Example was added, in an amount of 0.2 g, to each of 20 ml of ethanol solutions containing 0.01 M tungsten chloride, 0.03 M tungsten chloride, 0.05 M tungsten chloride, and 0.06 M tungsten chloride. Each of the mixed solutions was lightly stirred and then left to stand at room temperature for two hours. The mixed solution was then subjected to centrifugation, washed with distilled water, and dried at room temperature for one night to obtain a light purple powder. It was confirmed that the amount of deposition of tungsten oxide measured by fluorescence X-ray analysis was increased as the concentration of tungsten chloride increased (Table 3).

TABLE 3
Composite of composite nanofiber and tungsten oxide

| | Name of composite | | | |
|---|---|---|---|---|
| | 20-SNF | 20-SNF | 20-SNF | 20-SNF |
| | @LPEI/ | @LPEI/ | @LPEI/ | @LPEI/ |
| | 1-WO₃ | 3-WO₃ | 5-WO₃ | 6-WO₃ |
| SNF@LPEI raw material | 20-SNF | 20-SNF | 20-SNF | 20-SNF |
| | @LPEI | @LPEI | @LPEI | @LPEI |
| Concentration of tungsten | 0.01M | 0.03M | 0.05M | 0.06M |
| chloride | | | | |
| Amount of deposition of WO₃ | 20.7 | 47.3 | 55.8 | 64.8 |
| (%) | | | | |

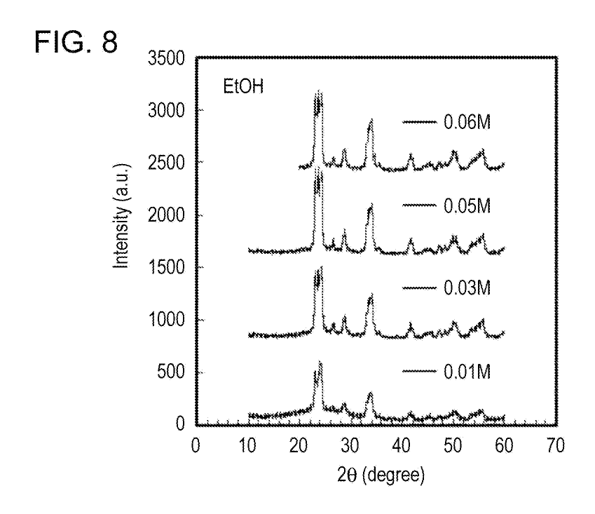

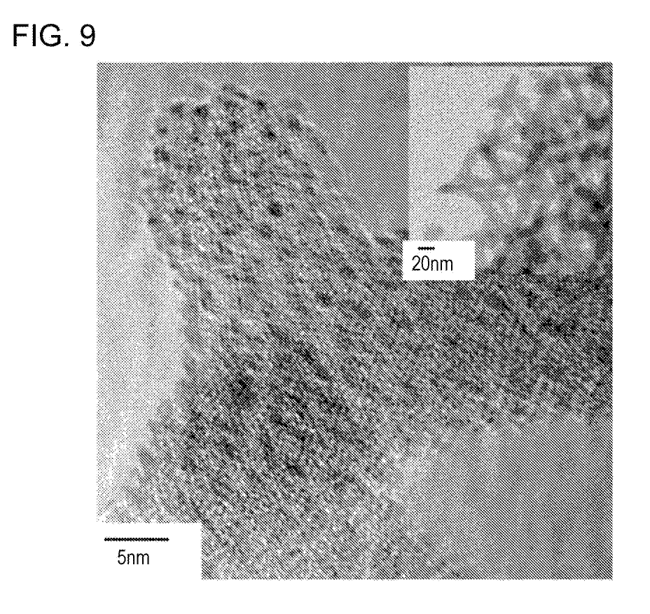

These samples were calcined in the air at 600° C. for one hour to remove LPEI, and thus the nanocrystallization of tungsten oxide and the bonding of tungsten oxide with a silica nanofiber were achieved. As a result of the X-ray diffraction analysis of the calcined powders of silica nanofiber/tungsten oxide nanocrystal composites, it was confirmed that a tungsten oxide crystal phase was present in all the samples (FIG. 8). Through the transmission electron microscopy of a sample (silica nanofiber/tungsten oxide nanocrystal composite) obtained by calcining 20-SNF@LPEI/3-WO₃, many crystallites having a size of 1 to 2 nm were observed on the surface of the fiber (FIG. 9).

### Example 3

### <Silica Nanofiber/Titanium Oxide·Tungsten Oxide Nanocrystal Composite>

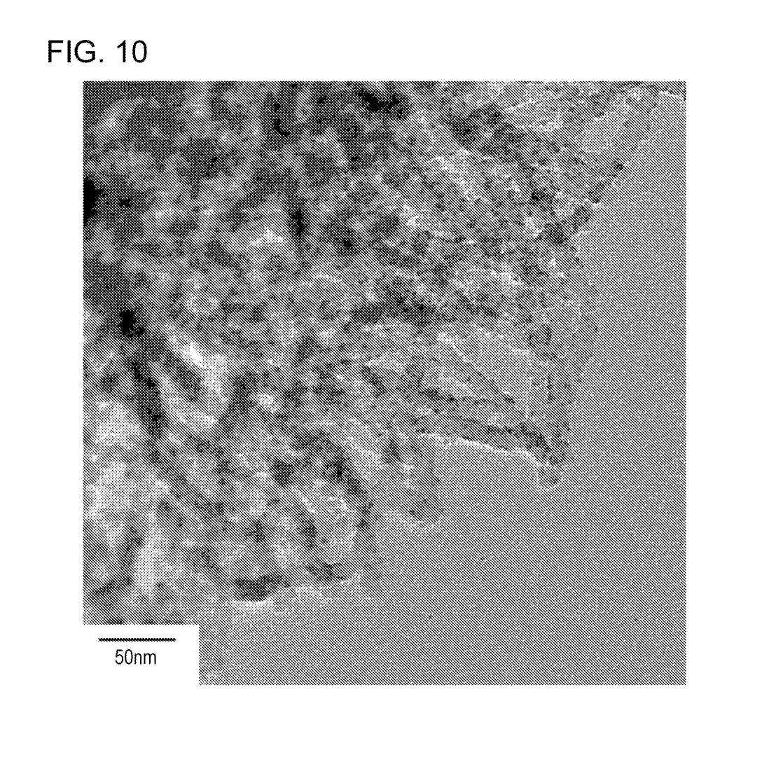

The powder of 10-SNF@LPEI associate of the composite nanofiber obtained in Synthetic Example was added, in an amount of 0.5 g, to 100 ml of an ethanol solution containing 2 vol % titanium (IV) tetraethoxide, and a reaction was caused to proceed at room temperature for one hour under stirring. Subsequently, 4 ml of an ethanol solution containing 0.25 M tungsten chloride was added thereto, and a reaction was further caused to proceed at room temperature for one hour. The powder was washed with ethanol using a centrifuge, vacuum dried, and calcined at 600° C. for one hour. As a result of fluorescence X-ray analysis, it was found that this composite was constituted by 6 wt % of tungsten oxide, 52 wt % of titanium oxide, and 42 wt % of silica. As a result of transmission electron microscopy, the composite was found to be an aggregate of fibers each having a diameter of about 15 nm and a metal oxide nanocrystal was observed on the surface of the fibers in the form of black spots (FIG. 10).

### Example 4

### <Silica Nanofiber/Zinc Oxide Nanocrystal Composite>

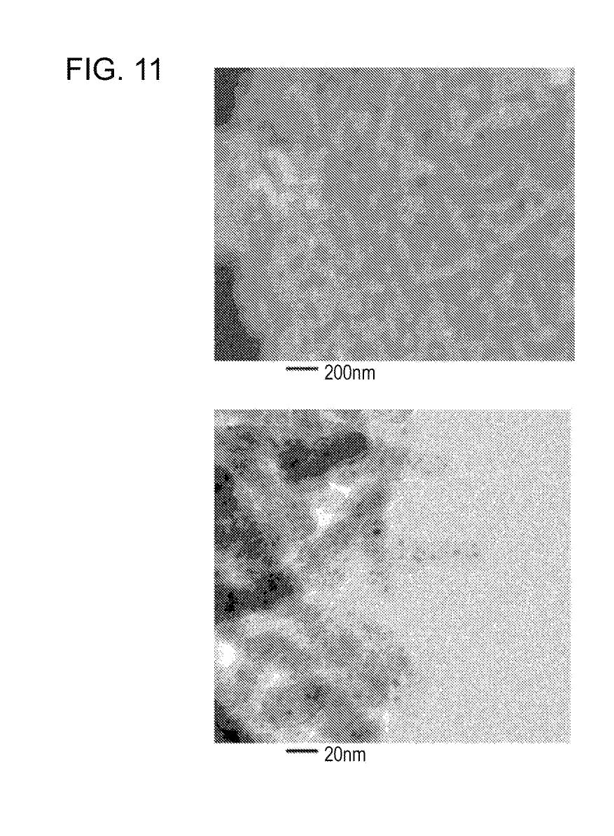

The powder of 10-SNF@LPEI associate of the composite nanofiber obtained in Synthetic Example was added, in an amount of 0.5 g, to 10 ml of Zn(OAc) aqueous solution (0.1 mol/L) and a reaction was caused to proceed at room temperature for one hour. The powder was washed, dried, and then calcined at 400° C. for one hour. The resultant powder was again mixed with 20 mL of Zn (NOₛ) aqueous solution (0.1 mol/L) and 5 mL of polyethyleneimine (SP-200 manufactured by NIPPON SHOKUBAI CO., LTD.) aqueous solution (0.2 mol/L), and the mixture was stirred at 80° C. for 90 minutes. The powder was washed with water and ethanol and then dried at room temperature. The dried powder was calcined at 500° C. for three hours. As a result of fluorescence X-ray analysis, it was confirmed that 13.9% of zinc oxide was contained. As a result of transmission electron microscopy, it was confirmed that black spots derived from zinc oxide were present on the surface of the silica nanofiber (FIG. 11). The size of the black spots was 2 to 3 nm.

### Example 5

### <Luminous Body of Silica Nanofiber/Zinc Oxide Nanocrystal Composite>

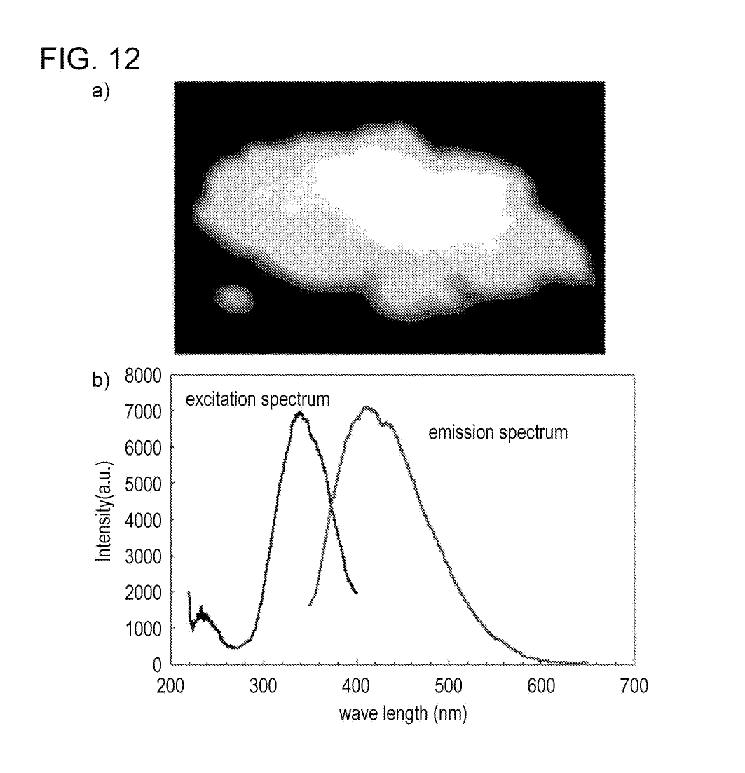

When the powder of the silica nanofiber/zinc oxide nanocrystal composite obtained in Example 4 was irradiated with black light, the powder brightly emits light (FIG. 12a). Furthermore, the powder was sandwiched between two quartz glass sheets, and the fluorescence spectrum was measured with F-4500 Fluorescence Spectrophotometer (manufactured by Hitachi, Ltd.) (slit conditions: Ex=2.5 nm and Em=2.5 nm). The fluorescence had a wavelength of 400 to 600 nm and a significantly strong intensity (FIG. 12h).

### Example 6

### <Film-Type Luminous Body Composed of Silica Nanofiber/Zinc Oxide Nanocrystal and Polyethylene>

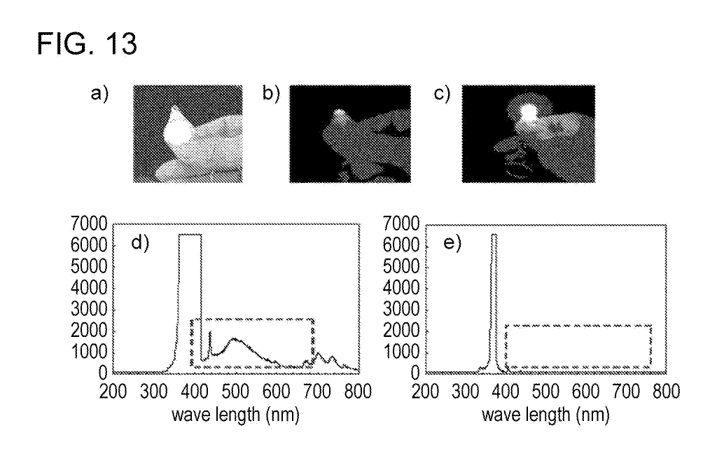

Ten parts of the powder of the composite obtained by the method in Example 4 was mixed with 90 parts of polyethylene. The mixture was inserted into a biaxial kneader (KZW15TW-45MG-NH-700 manufactured by TECHNOVEL CORPORATION) and melt-kneaded at 250° C. for 15 minutes. After the completion of the kneading, the blended sample was taken out of a kneading chamber and solidified by cooling while being sandwiched between two iron sheets. Thus, the sample was formed into a film having a thickness of about 2 mm. The film was used as a cap of a commercially available ultraviolet chip (FIG. 13a). In the lighted states of capped and uncapped chips, the lights were observed by taking an image and the wavelengths of the lights were measured with USE 4000 Spectroscope (manufactured by Ocean Optics, Inc.). FIGS. 13b and 13c show images of the lights in a lighted state. As is clear from the images, the brightness of the capped chip is much higher than that of the uncapped chip. Furthermore, the capped chip emitted visible light mainly having a wavelength of 500 nm in terms of a reflection spectrum (FIG. 13d). However, the uncapped chip had low brightness and thus no spectrum was observed in a visible wavelength range (FIG. 13e). This suggests that the film containing a powder composed of the composite is effective for the applications of ultraviolet absorption illuminators.

1-9. (canceled)

10. A method for producing a silica nanofiber/metal oxide nanocrystal composite in which a metal oxide nanocrystal (A) is bonded to a silica nanofiber (B) constituting a disc-shaped network structure, the method comprising:
(I) a step of causing association of a polymer having a linear polyethyleneimine skeleton by mixing a hot water solution and ice with each other in a mass ratio of 10/90 to 90/10, the hot water solution being obtained by dissolving, in advance, the polymer in hot water having a temperature of 70 to 100° C. in an amount of 0.5 to 10% by mass, so that a water medium has a temperature of 3 to 15° C. during the mixing;
(II) a step of adding alkoxysilane to a water-based medium that contains an associate and is obtained in the step (I) to forma composite nanofiber including the associate as a core and silica that covers the associate, while the composite nanofiber spontaneously forms a disc-shaped network structure;
(III) a step of depositing a metal oxide (A′) on a surface of the composite nanofiber constituting the disc-shaped structure obtained in the step (II) by mixing the disc-shaped structure with a hydrolyzable metal compound (C) in the water-based medium; and
(IV) a step of calcining, at 400 to 1250° C., the disc-shaped structure in which the metal oxide (A′) is deposited on the surface of the composite nanofiber and that is obtained in the step (III) to form a silica nanofiber (B) through removal of the polymer in the composite nanofiber, to convert the metal oxide (A′) into a metal oxide nanocrystal (A), and to bond the metal oxide nanocrystal (A) to the silica nanofiber (B).

11. The method for producing a composite according to claim 10, wherein the silica nanofiber (B) has a thickness of 5 to 20 nm and the metal oxide nanocrystal (A) has a size of 2 to 10 nm.

12. The method for producing a composite according to claim 10 or 11, wherein a metal species of the metal compound (C) is at least one metal selected from titanium, zinc, tungsten, barium, iron, zirconium, cobalt, and manganese.

13. The method for producing a composite according to claim 10 or 11, wherein the metal compound (C) is a metal alkoxide, a metal acetate, a metal nitrate, or a metal chloride.

14. The method for producing a composite according to claim 12, wherein the metal compound (C) is a metal alkoxide, a metal acetate, a metal nitrate, or a metal chloride.

15. A silica nanofiber/metal oxide nanocrystal composite whose entire shape is a disc-like shape having a diameter of 5 to 20 μm and a thickness of 50 to 500 nm,
wherein the composite has a basic structure in which a metal oxide nanocrystal (A) having a size of 2 to 10 nm is bonded to a surface of a silica nanofiber (B) having a thickness of 5 to 20 nm and is formed by intertwining the basic structure.

16. The composite according to claim 15, wherein a metal oxide of the metal oxide nanocrystal (A) is at least one metal oxide selected from titanium oxide, zinc oxide, tungsten oxide, barium oxide, iron oxide, zirconia, cobalt oxide, and manganese oxide.

17. A luminous body that is excited through irradiation with ultraviolet rays and emits light in a visible range, wherein the metal oxide in the silica nanofiber/metal oxide nanocrystal composite according to claim 15 or 16 is zinc oxide.
